(19) United States
(12) Patent Application Publication
(10) Pub. No.: US 2015/0106201 A1
(43) Pub. Date: Apr. 16, 2015

(54) METHOD OF DELIVERING A SEARCH ENGINE ADVERTISEMENT

(71) Applicant: SIDHANT AGARWAL, BANGALORE (IN)

(72) Inventor: SIDHANT AGARWAL, BANGALORE (IN)

(21) Appl. No.: 14/138,010

(22) Filed: Dec. 21, 2013

(30) Foreign Application Priority Data
Oct. 14, 2013 (IN) 4614/CHE/2013

(51) Int. Cl. G06Q 30/02

(52) U.S. Cl. CPC G06Q 30/0256
USPC 705/14.54

(57) ABSTRACT

The present invention relates to a method of delivering advertising content on search engines. The present invention provides a method of delivering a search engine advertisement on a user's computer. The method comprises steps of loading the search page with a search query field on a display of the user's computer, receiving one keyword from the user into the search query field, executing a search for the keyword and generating search result, displaying the search result in a Search Engine Result Page on the user's computer and replacing the pointer image on the display of the user's computer with a customized image.

### CROSS-REFERENCE TO RELATED APPLICATIONS

This application claims the benefit of Indian Patent Application Serial Number 4614/CHE/2013, filed Oct. 25, 2013, which is incorporated in its entirety by reference herein.

### FIELD OF THE INVENTION

The present invention relates in general to the delivery of content over internet, and more particularly relates to the method of delivering advertising content on search engines.

### BACKGROUND OF THE INVENTION

A web search engine is a software system that is designed to search for information on the World Wide Web. The search results are generally presented in a line of results often referred to as search engine results pages (SERPs). The information may be in web pages, images, information and other types of files. The search engines maintain real-time information by running an algorithm on a web crawler.

Web search engines work by storing information about many web pages, which they retrieve from the webpage's HTML. These pages are retrieved by a web crawler (also known as a spider) which is an automated web browser which follows every link on the site. The contents of each page are then analyzed to determine how it should be indexed, for example by extracting words from the titles, page content, headings, or meta tags. Data about web pages are stored in an index database for use in later queries. A query from a user can be a single word. The index helps find information relating to the query as quickly as possible.

When a user enters a query by using keywords into a search engine, the engine examines its index and provides a listing of best-matching web pages according to its criteria, usually with a short summary containing the document's title and sometimes parts of the text. The index is built from the information stored with the data and the method by which the information is indexed

Search engine marketing (SEM) is a form of internet marketing that involves the promotion of websites by increasing their visibility in search engine results pages (SERPs) through optimization and advertising. In internet marketing, search engine advertising is a method of placing online advertisements on the SERPs.

Search advertisements are targeted to match keywords entered on search engines. This targeting ability has contributed to the attractiveness of search advertising for advertisers. Consumers will often use a search engine to identify and compare purchasing options immediately before making a purchasing decision. The opportunity to present consumers with advertisements tailored to their immediate buying interests encourages consumers to click on search ads instead of unpaid search results, which are often less relevant.

Search advertising is sold and delivered on the basis of keywords by the search engine companies. Search engines conduct running auctions to sell ads according to bids received for keywords and relative relevance of user keywords to ads in the inventory.

Through the same search-engine advertising services, ads can also be placed on web pages with other publishers. When the publisher of a web page arranges with a search engine firm to have ads served up on that page, the search engine applies their indexing technology to associate the content of that page with keywords. Those keywords are then fed into the same auctioning system that is used by advertisers to buy ads on search engine results pages. Advertising based on keywords in the surrounding content or context is referred to as ‘contextual advertising’. Advertisers can choose whether to buy ads on search result pages (search advertising), published content pages (contextual advertising), or both.

Search engine marketing (SEM) includes two main methods Organic Search Engine Optimization (SEO) and Pay Per Click Advertising (PPC).

Search engine optimization is the practice of applying techniques to maximize a webpage's ranking in organic, or natural search results. Organic search results are the rankings of Web pages returned by a search engine when an user searches for a specific “keyword” or “keyword phrase”.

In Pay Per Click Advertising (PPC) ads are placed of a website with a search engine, such as Google or Yahoo. The advertiser bids the amount which he is willing to pay per click. The more is the bid amount, the higher the ad will appear in the search engine results.

The inventor of the present invention proposes a new method of delivering advertisement in connection to search engines in a cost effective and secure manner without disturbing the existing advertising methods on the SERPs.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent therein.

In one aspect, the present invention provides a method of delivering a search engine advertisement on a user's computer. The method comprises loading a search page with a search query field on a display of the user's computer, receiving at least one keyword from the user into the search query field of search engine, executing a search for the keyword and generating search result, displaying the search result in a Search Engine Result Page, and delivering the advertisement by replacing a pointer device image on the display of the user's computer with a customized image.

In another aspect of the present invention, the customized image is a logo of a highest bidder for the keyword in the search query.

In yet another aspect, the present invention further includes deciding a highest bidder for the keyword in the search query.

In another aspect of the present invention, the search engine advertisement is delivered on a partner webpage of the search engine.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description taken in conjunction with the accompanying drawings in which:

FIG. 1 illustrates a web search process on a search engine;

FIG. 2 illustrates a sample screen shot of a search results page of Google with Pay per click ads;

FIG. 3 illustrates a default pointer on a SERP of the Google search engine;

FIG. 4 illustrates flowchart for the method of delivering a search engine advertisement, according to one embodiment of the present invention;

FIG. 5 illustrates the pointer on the SERP of the Google search engine, according to one embodiment of the present invention;

FIG. 6 illustrates a default pointer on a partner website of the Google search engine; and

FIG. 7 illustrates the pointer on the partner website of the Google search engine, according to one embodiment of the present invention.

Like reference numerals refer to like parts throughout the several views of the drawings.

### DETAILED DESCRIPTION OF THE DRAWINGS

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘at least’ do not denote a limitation of quantity, but rather denote the presence of at least one of the referenced item.

The terms ‘advertisement’ or ‘ads’ or ‘ad’ may be used herein interchangeably and refer to convey the same meaning. The word ‘pointer’ or ‘cursor’ have been used interchangeably and refer to the component used for pointing to a particular location on the computer display screen in response to the movement of a mouse, track ball, touchpad, etc.

Similarly the terms ‘normal pointer’ or ‘default pointer’ or ‘original pointer’ may be used herein interchangeably and refer to convey the same meaning. The terms ‘sponsor’ or ‘advertiser’ may be used herein interchangeably and refer to convey the same meaning.

In an exemplary embodiment, the present invention provides a method of delivering a search engine advertisement. The method of the present invention may be used for mass implementation and used in an easy, cost effective, environment friendly and productive way.

It is to be understood that the improvements of the present invention are applicable to any of a number of method of delivering search engine advertisement other than those which are specifically described below. Such methods will be readily understood by the person of ordinary skill in the art, and are achievable by causing various changes that are themselves known in state of the art.

The trademarks, website names, advertising methods etc used in the present description are property of the respective owner companies and used herein for illustrative purposes only. The inventor does not claim any rights on it.

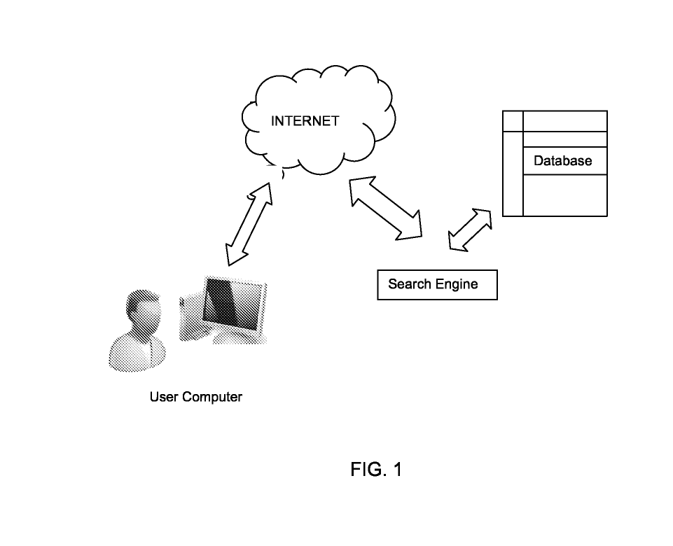

Referring to FIG. 1 that illustrates a web search process on a search engine. A user with a computer which is connected to internet can open the search engine website by typing its web address in the internet browser. The search engine has a search query input box, where the user may enter his query formed by one or more keywords. The search engine takes that query and searches the content of its database and returns the search results to the user computer. The search results are presented on a search engine results page (SERP). The search results returned for a query are dependent on the algorithm used by the particular search engine. The search results are also accompanied by links to sponsored advertisement pages of the advertisers. The advertisements (hereafter referred as ‘ads’) include different specific advertisements, for example from different advertisers, and also include different advertisement techniques. Advertisement techniques refer to the type of advertisement and the underlying advertising model, such as how the advertiser pays for the advertising for example on a per-click basis, pay-per-view basis, etc.

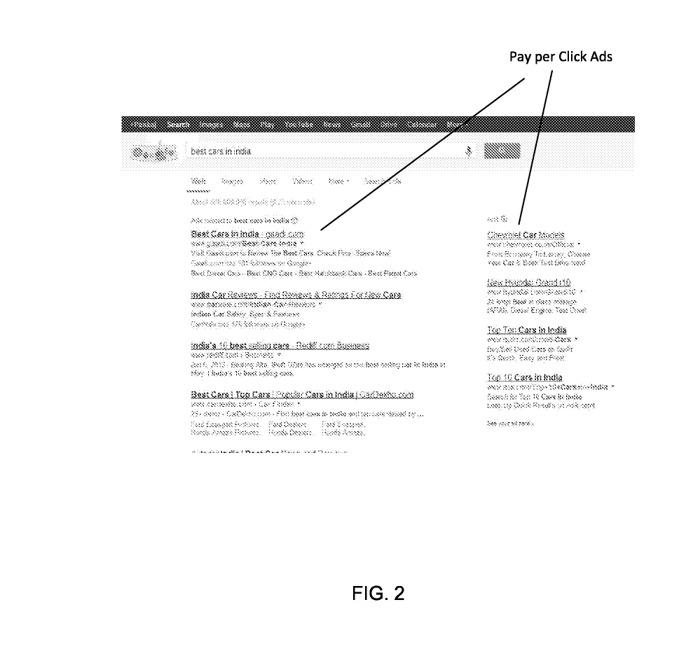

Referring to FIG. 2 which illustrates the Pay per click ads on a SERP of a search engine. The search engine may be any search engine, such as a search engine portal referenced by the user through a URL. The search engine may be capable of receiving search requests having search terms from one or more processing devices and accessing the web content databases that provide the search results on a search results page (SERP).

In FIG. 2 the search engine ‘Google’ is used for illustration. A query with keywords “best cars in India” is typed on the search box and run on the Google search engine which generates the results page. The SERP shows search results and ads. In response to a search request, the search engine determines different advertisements that may be included with the search results to be displayed on the search engine results page (SERP). The ads are displayed on the top and to the right of the search results. The ads are clearly titled with the word ‘Ads’ to differentiate the search results from the ads.

These ads may be pay-per-click ads in which the advertiser is charged when a user clicks on these ads or pay-per-view ad in which the advertiser is charged for how many times the ad is displayed. The ad of the advertiser who bid the highest price for the keywords “best cars in India” is shown. As seen from the figure the ads of ‘gaadi.com’ and ‘carwale.com’ are shown above the search results. Similarly the ads of ‘chevrolet’ and ‘hyundai’ appear on the right of the search results. This is one form of advertising on search engine, where an advertiser bids on keywords to come on top or right of the search results for the query including the keywords.

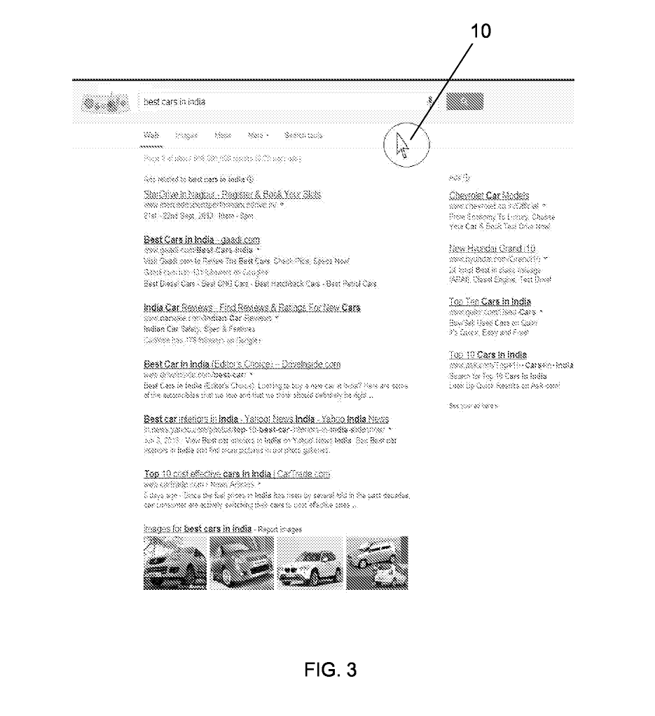

Referring to FIG. 3 which illustrates a default pointer 10 on a SERP of the Google search engine. The pointer may be of mouse used on a desktop or finger pointer of a laptop or a touch screen computing phone. The pointer shows a big ‘arrow’ normally and when the mouse is moved, the pointer also moves with the mouse to the desired position on screen. The pointer turns from ‘arrow shape’ to ‘hand shape’ when moved on a hyperlink on the webpage. The shape of ‘arrow’ and ‘hand’ for the pointer are default shapes in an operating system for example Windows. The shapes of the pointer may be changed to some predefined shapes available in the customization options of the operating system. This customization of shape applies to all programs and webpages viewed on that particular computer system.

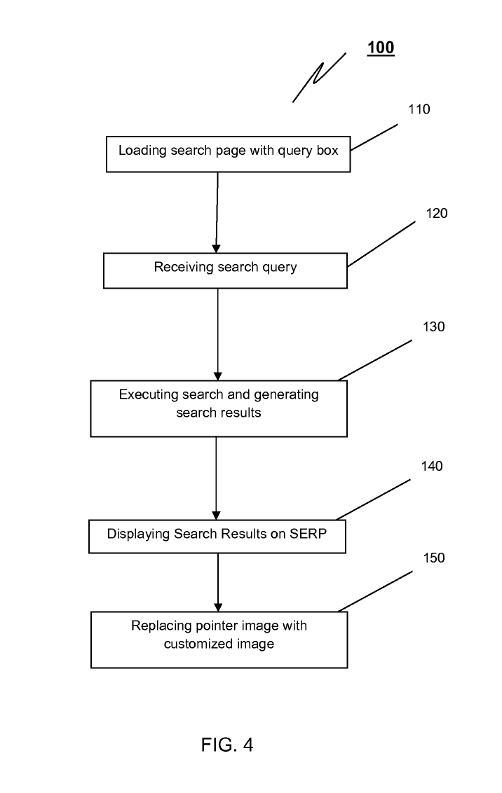

FIG. 4 illustrates flowchart for the method 100 of delivering a search engine advertisement, according to one embodiment of the present invention. The method 100 starts with step 110 of loading a search page with a search query field on a display of the user's computer. The user opens the search engine page by typing the web address of the search engine in the internet browser and the search engine loads the search page with query box.

In step 120 at least one keyword is received from the user into the search query field of the search engine. The user forms a search query using one or more keywords and types it into the search query box of the search engine and hits the command for the search engine to execute the search. The command for executing the search may be given by hitting an ‘Enter’ key on a desktop/laptop or by clicking a submit/search button on the search engine page. The command may be given by tapping on the search/submit button in case of touch screen computing devices.

Next step 130 is execution of the search for the at least one keyword and generating a search result. The search engine executes the search to check the keywords of the search query in its database and generates the search results based on its algorithm.

In step 140 the search results are displayed in a Search Engine Result Page (SERP) on the user's computer. The results are presented as per the style definition of the page. The search results may be displayed with a short summary of the content and hyperlinks of the webpages. The SERP also includes ads placed on different locations along with the search results.

In next step 150 the pointer image on the display of the user's computer is replaced with a customized image 20 to display the ad of the advertiser. A user's pointer on the computing device is an important display space since it generally represents the user's point of focus on a particular page being displayed.

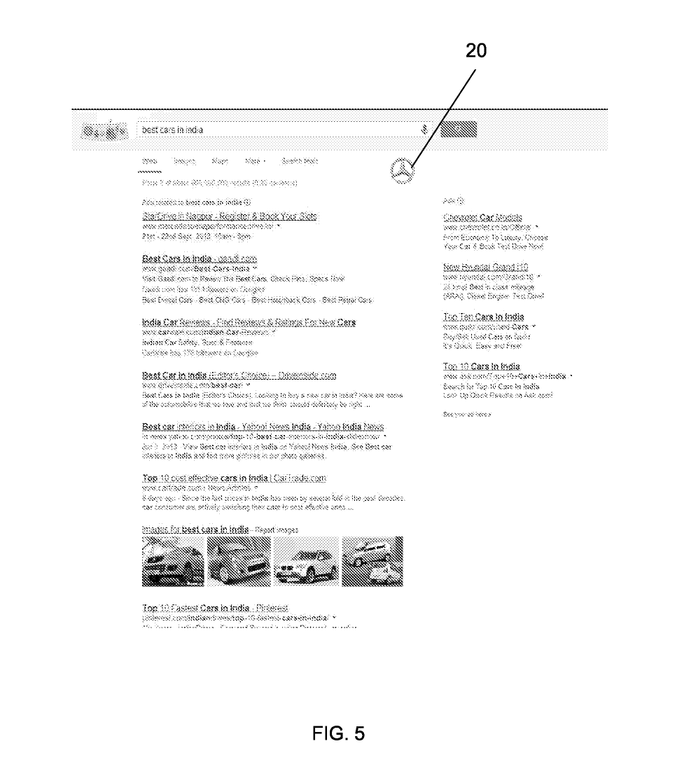

In one embodiment of the present invention, the customized image 20 may be a logo of a company of the advertiser. As shown in FIG. 5, the logo of advertiser ‘Mercedes Benz’ has replaced the default pointer 10 image. The method 100 according to present invention thus provides another advertisement technique on search engine in addition to the display ads. For the sake of clarity herein the advertisement delivered according the method 100 is also referred to as ‘pointer ad’. The advertiser bids for keywords according to his business and provides the logo to be shown in the pointer ad.

In another embodiment of the present invention, the logo of of the highest bidder for the keyword is shown as advertisement. The method further includes deciding a highest bidder for the keyword. When a user performs search on the search engine by entering keywords, the search engine displays search results for the keywords on the SERP and further decides who the highest bidder for those keywords is. This decision may be done by comparing the keywords and bids from different advertisers and selecting the logo of the highest bidder to display in the pointer ad.

All search engines generally have a User Interface (UI) which may be accessed by the advertisers and the internal team of the search engine. Most search engines also provide internal bulk upload tools, where advertisers may provide and make changes to the keywords, ads, images, their bids for different keywords in bulk. The search engine team may also perform the same activities for advertisers on request. Similar tools may be provided by search engines to provide customized images used for pointer ads to be added in the existing accounts that already contain keywords and ads.

Based on the advertiser's requirements a separate account/campaign/ad group may also be created exclusively for the pointer ads. The advertisers may make a pool of keywords which will act as the linking between what the user is searching for and the advertiser bids. The same principle may be used across the network of partner websites operated by the search engine.

For example if one of the keywords in the pool of keywords is “best food” and:
‘Advertiser 1’ has bid on that keyword an amount of $2
‘Advertiser 2’ has bid on that keyword an amount of $2.75
‘Advertiser 3’ has bid on that keyword an amount of $2.2

Then when a user types “best food in India” as the search query, the search engine executes the search and returns the search results along with the display ads on a SERP. In addition the search engine performs the phrase match with the pool of keywords and decides the highest bidder for the pointer ads and changes the pointer image to the logo of ‘Advertiser 2’.

In order to charge the advertiser, the search engine may keep track of the number of times the pointer ad of the advertiser is displayed, number of clicks on the pointer ad and may provide the advertisers with a performance report mentioning the keyword entered and impressions gained and the time period. Several other such reports may also be provided. The advertiser may be provided with a dashboard type environment from where he can provide keywords, images, and bids for different keywords to start his advertising campaign. The dashboard may also provide the performance report to be viewed by the advertiser.

In another embodiment of the present invention, the customized image 20 moves as the user moves the pointer. The pointer image is replaced by the customized image 20 but acts as the default pointer image only and moves as the user moves the pointer on the display of his computer devices.

In yet another embodiment of the present invention, the customized image 20 is displayed as long as the user is on the Search Engine Result Page. After performing a search and getting the search results, a user may click on any of the results or ads of his choice on the SERP. The user is then directed to the webpage of his selected result or ad. The user spends a significant time to view the search results and make his choice for clicking to read further. The pointer ad with the customized image 20 of the present invention may be displayed as long as the user is on the SERP. Once the user leaves the SERP the customized pointer image may again be replaced by the default pointer 10 image.

In another embodiment the customized image 20 may be displayed for a pre-specified time. For a pre-specified time when the user is on the SERP, the logo of the highest bidder of the search keywords may be shown. In yet another embodiment of the method 100 of the present invention, after a pre-specified time the customized image 20 may be again replaced with the default pointer 10 image. For example say the logo of the advertiser is shown in the pointer ad and after 10 seconds, the logo is again replaced by original arrow pointer on the user's display of computer device.

In another embodiment after the pre-specified time the customized image 20 is replaced with a new customized image. The logo is shown in the pointer ad for sometime (say 10 seconds) and then the logo is changed to another new customized image different from the previous customized image.

In one embodiment the new customized image is logo of a second highest bidder for the at least one keyword. For example say for 10 seconds the logo of the highest bidder is displayed and after that that logo is replaced with another logo of the second highest bidder for the search keywords.

Again taking the example quoted earlier say if one of the keywords in the pool of keywords is “best food” and:
‘Advertiser 1’ has bid on that keyword an amount of $2
‘Advertiser 2’ has bid on that keyword an amount of $2.75
‘Advertiser 3’ has bid on that keyword an amount of $2.2

When the user searches for ‘best food in Bangalore’ in the search engine, the search engine displays the results and pointer ads on the SERP. The logo of the highest bidder which is ‘Advertiser 2’ is shown in the pointer ad for a pre-specified time (say 10 seconds) and after 10 seconds it is replaced by the logo of ‘Advertiser 3’ who is the second highest bidder for the keywords ‘best food’. This may go on and if the user stays for longer time on the SERP then after sometime the logo of the ‘Advertiser 3’ may be replaced with next highest bidder which is ‘Advertiser 1’. Say for first 10 seconds logo of ‘Advertiser 2’ is shown, for next 10 seconds logo of ‘Advertiser 3’ may be shown and after that logo of ‘Advertiser 1’ may be shown. After all the logos of the advertisers are shown for the time as per the search engine ad, the logo may again be replaced with the default pointer 10 image. In one embodiment after all logos are shown in one cycle, another cycle may again begin from the logo of ‘Advertiser 2’.

The pre-specified time may be defined by the search engine. The search engine may also charge the advertisers to display their logos alone for the whole time the user is on the SERP or offer to charge differently if other logos are also shown combinely.

In one embodiment of the present invention, the search engine advertisement may be delivered on a partner webpage of the search engine. The advertisement of the present invention which is pointer ad may also be displayed on the webpages of the partner websites of the search engine. For example ‘Youtube.com’ is a partner website of ‘Google’ search engine, so a webpage on youtube.com may display pointer ad. The advertisement may be delivered based on a contextual analysis of the content of the webpage or a highest bidder for displaying the advertisement on the webpage or a combination thereof.

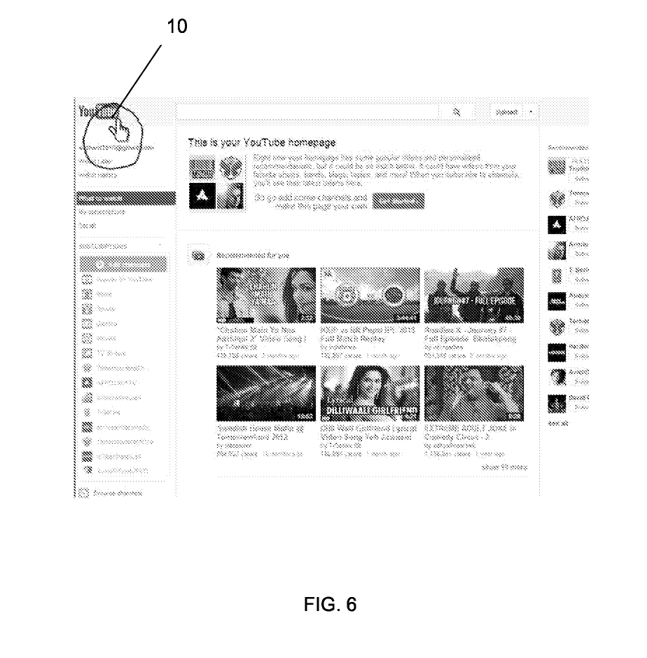

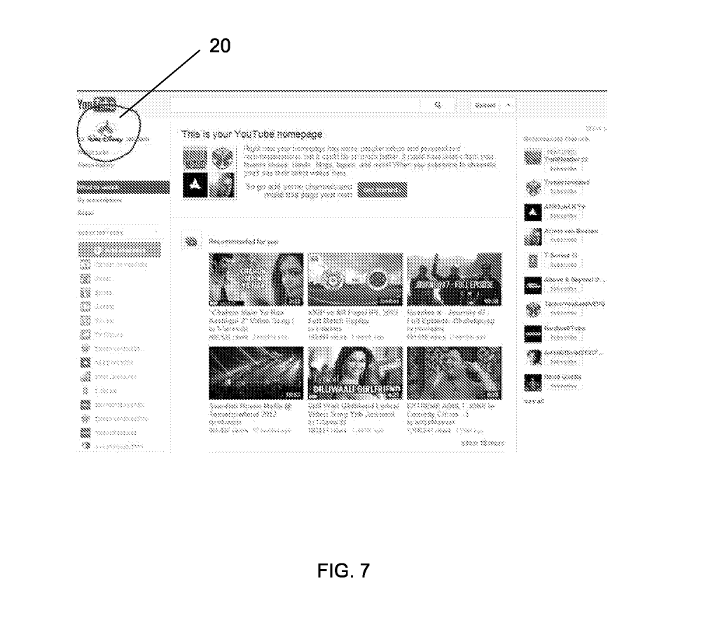

Referring to FIG. 6 which illustrates a default pointer 10 on a partner website ‘youtube.com’ of the Google search engine. The pointer is the default pointer of ‘hand image’. When the pointer ad of the present invention is displayed the ‘hand image’ changes to a customized image 20 which is logo of ‘Walt Disney’ as shown in FIG. 7.

The method of delivering the advertisement according to the present invention may be implemented by a system including an advertising server having a network interface for coupling the server to a computer network such as internet. The server includes a processor having software adapted to implement the method 100. The software may receive a request for search in the form of a search query having one or more keywords, select search results to be shown for the query based on the algorithm of the search engine, decide the advertisements to be shown associated with the keywords in the query and the highest bidder, deliver the search results and the advertisements in a SERP a user computer. The system may include standard components like processor, memory, available and used in the state of the art for the method to be implemented.

The method 100 of advertising according to the present invention has many advantages for the advertisers and the search engine company.

For advertisers the advantages are as below:
The advertisers have an extra advertisement option to bid on the keywords that they want to target
The advertisers gain more visibility because sub-consciously any user's eyes are always tracking the pointer
The advertisers get a more refined way of display advertising since they may be able to display their logo to targeted audience.

The advantages for the search engines are:
Pointer ads are a chargeable model where the advertisers pay the search engine based on number of times their logo is displayed
This method creates a new and more involved user experience and tends to delight the user.

In other instances, well-known methods, procedures, and ingredients have not been described herein, so as not to obscure the particular embodiments of the present invention. Further, various aspects of embodiments of the present invention may be made using various systems and methods.

Although a particular exemplary embodiment of the invention has been disclosed in detail for illustrative purposes, it will be recognized to those skilled in the art that variations or modifications of the disclosed invention, including the rearrangement in the steps of the method, changes in steps, variances in terms of devices may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

I claim:

1. A method of delivering a search engine advertisement on a user's computer, comprising the steps of:
loading a search page with a search query field on a display of the user's computer;
receiving at least one keyword from the user into the search query field of the search engine;
executing a search for the at least one keyword and generating a search result;
displaying the search result in a Search Engine Result Page on the user's computer; and
replacing a pointer image on the display of the user's computer with a customized image.

2. The method according to claim 1, wherein the customized image is a logo.

3. The method according to claim 2, wherein the logo is of a highest bidder for the at least one keyword.

4. The method according to claim 1, further includes deciding a highest bidder for the at least one keyword.

5. The method according to claim 1, wherein the customized image moves as the user moves the pointer.

6. The method according to claim 1, wherein the customized image is displayed as long as the user is on the Search Engine Result Page.

7. The method according to claim 1, wherein the customized image is displayed for a pre-specified time.

8. The method according to claim 7, wherein after the pre-specified time the customized image is replaced with the pointer image.

9. The method according to claim 7, wherein after the pre-specified time the customized image is replaced with a new customized image.

10. The method according to claim 9, wherein the new customized image is logo of a second highest bidder for the at least one keyword.

11. The method according to claim 1, wherein the search engine advertisement is delivered on a partner webpage of the search engine.

12. The method according to claim 11, wherein the search engine advertisement on the partner webpage is delivered based on at least one criterion from a list including a contextual analysis of a content of the webpage, a highest bidder for displaying the advertisement on the webpage or a combination thereof.
